(19) United States
(12) Patent Application Publication
(10) Pub. No.: US 2011/0064572 A1
(43) Pub. Date: Mar. 17, 2011

(54) VANE SEALING METHODS IN OSCILLATING VANE MACHINES

(76) Inventors: Jedd N. Martin, Providence, RI (US); Bradley R. Fierstein, Boston, MA (US)

(21) Appl. No.: 12/883,078

(22) Filed: Sep. 15, 2010

Related U.S. Application Data
(60) Provisional application No. 61/242,580, filed on Sep. 15, 2009.
(60) Provisional application No. 61/266,406, filed on Dec. 3, 2009.

(51) Int. Cl. F04D 29/10; B23P 15/00; F04D 29/38

(52) U.S. Cl. 415/230; 29/888.025; 416/223 R

(57) ABSTRACT

The invention relates to the uses and combinations of elastomeric seals, elimination of joints between segments of a seal grid, introduction of labyrinth seal profiles, abradable or conformable vane coatings, and crushable vanes or vane edges to provide lower leakage, lower friction, lower operating temperatures, and higher efficiency within an Oscillating Vane Machine.

### RELATED APPLICATIONS

This application claims the benefit of, U.S. Provisional Application No. 61/242,580, filed Sep. 15, 2009, and U.S. Provisional Application No. 61/266,406, filed Dec. 3, 2009. The entire teachings of the above applications are incorporated herein by reference.

### FIELD OF THE INVENTION

The present disclosure relates to methods for sealing the vanes of an Oscillating Vane Machine (OVM), in particular, to improvements to known contact and clearance seals, and the introduction of hybrid seals.

### BACKGROUND OF THE INVENTION

A number of OVMS are known in the art. For efficient operation of an OVM configured as a gas compressor, vacuum pump, engine, expander or otherwise, effective sealing around the vane is critical. In the case of a gas compressor, better vane sealing leads to higher efficiency, higher capacity and lower operating temperatures. In general, there have been two approaches to sealing vanes in OVMs: 1) contacting seals; and 2) clearance seals.

U.S. Pat. No. 2,413,636 (Long) first disclosed segmented metal seals that ride in glands within the vane of an OVM and that are activated with leaf-type springs. U.S. Pat. No. 3,507,119 (Kayser) then went on to apply helical springs to activate segmented metal seals. U.S. Pat. No. 4,080,114 (Moriarty) followed with an interlocking sealing grid that claimed to reduce leakage compared with previous seal designs. Moriarty further disclosed that due to the controlled motion of the vane, the seals need not carry any load and can therefore be made from a brittle, self-lubricating material. Such a material would obviate the need for lubrication within the working chamber. Lubrication, such as oil, functions not only as a lubricant between the vane seal and the chamber walls, but also as a seal between the joints and gaps of a sealing grid. Therefore, the design of the sealing grid for low leakage is all the more important for lubrication-free applications.

In addition to the contacting seals previously described, Moriarty discloses sealing by means of small clearances between the vane and the chamber walls. The benefits of a clearance seal are small frictional losses and no seal wear. The sealing potential of clearance seals is determined by two main parameters, the relative velocity of the vane surface and the housing surface, and the clearance between the vane surface and the housing surface. In order to have acceptable levels of leakage past the vane seals, clearances of approximately 0.001-0.002 inch must be consistently maintained which requires prohibitively expensive manufacturing processes for those parts.

U.S. Pat. No. 4,823,743 (Ansdale) discloses a sealing grid for an oscillating vane comprising at least one apex seal, one pair of side seals and one base seal that may be urged into contact with the chamber walls with springs or chamber pressure. Ansdale also discloses a vane with multiple sealing grooves that are activated with chamber pressure. Using multiple sealing grids, Ansdale sought to reduce the leakage of previous seal grid designs. However, the design introduced higher frictional losses, an increased part count, and an increase in size as a vane that houses two sealing grids is inherently larger than a vane that houses only one. This increased vane size leads to higher inertial loading, which is particularly detrimental for high speed OVMs.

Testing has shown significant leakage past vane seal grids that are activated with springs. In such seal grids, the seal must be less wide than the seal gland in the vane for free seal movement. In theory, chamber pressure closes this gap as the pressure pushes the seal to one side of the groove. Testing has also shown that tight lap joints and double-acting pressure-energization are mutually exclusive for spring-energized contacting seals in single grid layouts. Having two seal grids introduces more frictional losses than one seal grid, and this increased friction offsets a substantial portion of the efficiency gain from the reduced leakage. Therefore, a contacting sealing arrangement that eliminates the static leakage path while avoiding unnecessary frictional losses is highly desirable.

### SUMMARY OF THE INVENTION

To overcome the previously described limitations of the prior art, the present disclosure includes novel seals and sealing methods in the positive contact and clearance categories, and introduces a new hybrid category.

Specifically, the disclosure describes the uses and combinations of elastomeric seals, elimination of joints between segments of a seal grid, introduction of labyrinth seal profiles, abradable or conformable vane coatings, and crushable vanes or vane edges to provide lower leakage, lower friction, lower operating temperatures, and higher efficiency.

Positive Contact Methods

As used herein, “positive contact seal grids” means a seal configuration that is in physical contact with one or more surfaces such that during operation of the OVM, gas leaks in and around the surfaces in contact with the seal are minimized or eliminated. The prior art embodiments of OVMs have implemented vane seal activation (via a positive contacting force) by way of discrete axial springs, leaf springs, chamber pressure, or some combination thereof. A novel positive contact force mechanism is described here, specifically an elastomeric seal backing. This elastomeric seal backing consist of a pliable material (e.g. rubber, silicone, etc.) that is compressed between the vane seal and the vane surface, acting simultaneously to force the seal towards the chamber wall and also sealing the underside of the vane seals. Such an elastomeric-backed seal is also able to be activated by pressure in the chamber in which the vane is disposed within the OVM as well as discrete axial springs, and leaf springs.

In another embodiment, double contacting seals are provided. In this configuration there are two separate seal grids, one on each side of the vane each of which extends independently across the tip of the vane. With two sealing grids, leakage across the vane is reduced, but friction losses increase. In applications where a high pressure differential exists across the vane, the power saved by reducing leakage will be far larger than the power lost due to additional friction.

Vane seal performance can be further enhanced by the combination of elastomeric seal backing for positive contact force and the elimination of joints between segments of a seal grid. The result of these steps would be a one-piece seal design that was pliable enough to be fit into place over the vane as one piece. There would be some articulation of the seal at the corners. The benefit of this design would be that it would eliminate any fluid leakage through the lap joints, in addition to eliminating any leakage around the underside of the seals where the discrete springs were originally. This would lead to increased performance of an OVM by drastically decreasing vane seal leakage. Additionally, it is recognized that two, three, four or any higher number of vane seal grids will further reduce leakage and increase friction. Additionally, it is recognized that three, four or any higher number of vane seal grids will further reduce leakage and increase friction.

In one embodiment, the invention provides a positive-contact seal grid for a an oscillating vane machine vane wherein the vane comprises a tip, two sides and a bore, wherein the positive-contact seal grid comprises at least one seal selected from: an elastomeric-backed tip seal, an elastomeric-backed side seal, an elastomeric-backed bore seal or any combination thereof.

Clearance Methods

A clearance seal operates by the reduction of available flow area from one volume to another such that it inhibits fluid flow. A clearance seal does not require physical contact between the vane and the surface with which a seal is desired yet when the OVM is operating, gas leaks in and around the vane are minimized or eliminated. In general, the smaller the flow area and the tighter tolerances can be held to maintain small gaps, the better the clearance seal will perform.

In accordance with one embodiment of the invention, to improve the seal effectiveness or achieve the same seal effectiveness at larger clearances, the flat surfaces of the vane or the chamber are replaced with a labyrinth seal profile. Labyrinth seals are generally understood in the art to be more effective than flat walls in a clearance seal.

In another embodiment a clearance seal is provided through the use of an abradable coating. Some interference exists at first build between the vane and an abradable coating on the stator, or between an abradable coating on the vane and the stator. The OVM will go through a preliminary “break-in” period, where the machine will wear away the interfering material. The end result will be extremely tight clearances without the need for precise manufacturing tolerances.

In yet another embodiment, a clearance seal is provided through the use of a “crushable” vane. Interference exists at first build between the stator and the vane. The vane or perimeter of the vane is made from or coated with, a material that permanently deforms or “crushes” when the vane is assembled in the stator. Extremely tight clearances will result without the need for precise manufacturing tolerances. Further, the vane can be heated to a specific temperature before being “crushed” into position in the stator so that when cooled, a specific clearance results at the machine's operating temperature.

In another embodiment a clearance seal is provided through the use of a class of coatings described as “conformable.” A conformable coating is applied to the vane, the chamber walls or both. When the unit is assembled and the vanes are oscillated, the coating conforms to the counter-face leaving a very small gap without the need for exceedingly tight manufacturing tolerances. As the unit reaches operating temperature, the coating continues to conform to the counter-face resulting in a very small operating clearance and therefore low leakage.

Hybrid Methods

When designing contacting chamber seals for a compressor, the key parameters are (1) average surface speed, (2) average chamber temperature, and, if the seals are pressure activated, (3) chamber pressure. Based on these parameters, the designer can select a seal material, chamber wall material and spring (or elastomeric) pressure to give an appropriate balance of seal life, cost and effectiveness.

In an OVM, however, the average surface speed of the seal changes dramatically over the vane geometry. The tip seal has an average speed that is nearly four times that of the bore seal. If the bore seal speed is used in the seal design process, the tip seal will be insufficient, likely resulting in premature seal failure. Alternatively, if the tip seal speed is used, the side and bore seals will be overdesigned, which would unnecessarily increase the cost of the OVM.

To avoid these drawbacks, the invention provides a hybrid positive contact/clearance seal referred to herein as a “hybrid seal. In a hybrid seal, portions of the vane would be sealed with positive contact seals and portions would be sealed with clearance-type seals. Since, in general, clearance seals are better applied to areas of high relative velocity and contacting seals are better applied to areas of low relative velocity, a clearance type seal is a good fit for the tip seal region and a contacting seal is a good fit for the bore seal region.

In one embodiment of the hybrid seal, the tip sealing and much of the side sealing is accomplished with a clearance seal and the bore sealing and side sealing near the bore is accomplished with contacting seals. Sealing in this manner allows the vane seal designer to select a low cost contacting seal material at the same vane oscillation speed or increase the vane oscillation speed, use a high-performance seal material and increase the output of the OVM. In another embodiment, the side seal could extend all the way to the tip seal or the bore seal could be a clearance seal. There are many other possible configurations in accordance with the invention.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a cross sectional view of a two-vaned OVM of the prior art.

FIG. 2 is an exploded view of a positive contact seal grid for the vane of an OVM.

FIG. 3 is a three dimensional view of a one piece elastomeric seal grid for the vane of an OVM.

FIG. 4 is a three dimensional view of a double positive contact seal grid for the vane of an OVM.

FIG. 5 is a cross sectional view of an unsealed vane of an OVM and a vane modified with a labyrinth type clearance seal.

FIG. 6 is side view of an OVM vane with a conformable, abradable or crushable clearance seal.

FIG. 7 is a three dimensional view of an OVM vane with a hybrid seal.

### DETAILED DESCRIPTION OF THE INVENTION

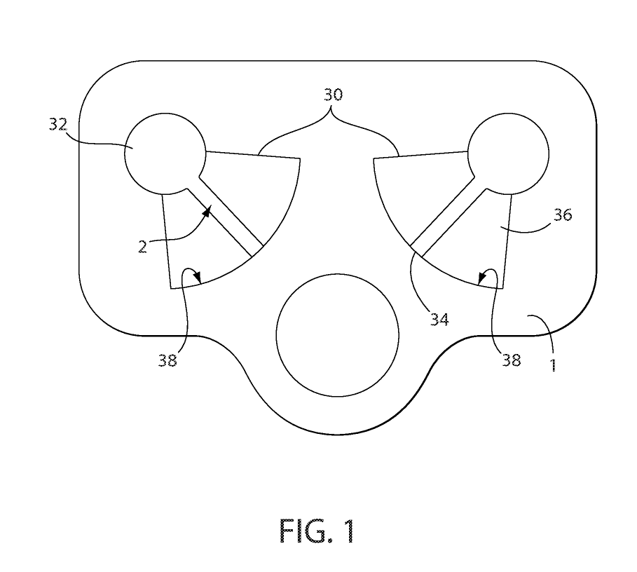

OVMs in which the present invention is useful include, but are not limited to, those described in U.S. Pat. Pub. 2009/0081061, the entirety of which is incorporated herein by reference. FIG. 1 represents one example of an OVM showing a two-vaned pivoted OVM as is described in U.S. Pat. Pub. 2009/0081061. Most OVMs have a similar basic configuration in that they comprise a vane 2 disposed within one or more chambers 30 of the OVM and the chambers 30 are integral to a stator 1 which houses one or more chambers 30. The vane 2 is secured at its bore 32 to a pivot shaft (not shown) and has a tip 34 that extends into a vane space 36 within the chamber 30. The path of the vane 2 generally defines the vane space 36 as it oscillates within the chamber 30 and either touches (depending on the seal configuration), or is in close proximity to the chamber walls 38 that circumvent the vane space. The clearance, positive contacting and hybrid seal grids of the invention serve to reduce leakage of gasses and fluids around the vane 2 and particularly between the vane 2 and the chamber walls 38.

Positive Contact Methods

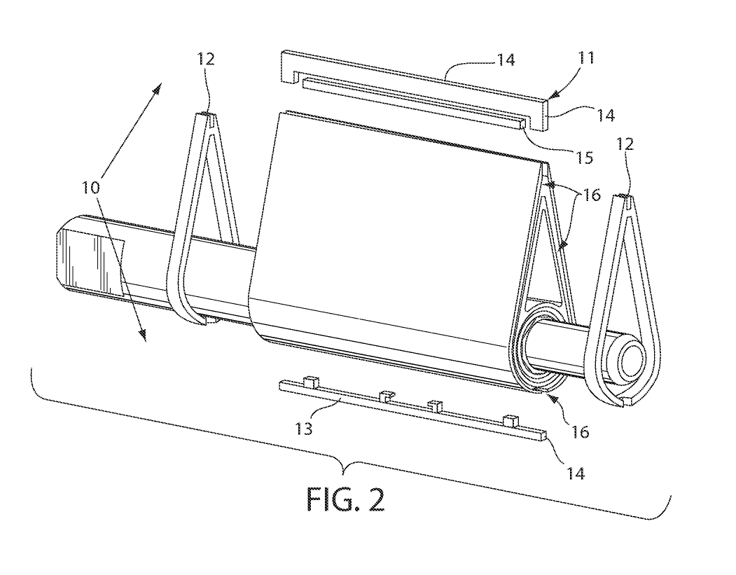

In accordance with one embodiment, FIG. 2 illustrates the segmented components (tip seal 11, side seal 12, bore seal 13) collectively comprising the seal grid 10 of a vane 2 in a typical OVM. Lap joints 14 are used to interconnect the various components and help reduce fluid leakage between them. As best seen in FIG. 2, a novel positive contact force mechanism is disclosed, specifically an elastomeric seal backing 15. The elastomeric seal backing 15 comprises an elastomeric material that is compressed between one or more of the tip seal 11, side seal 12, or bore seals 13 and the seal gland 16, acting simultaneously to force the seals 11, 12, 13 towards the chamber wall 4 while also sealing the underside of the seals 11, 12, 13 within the seal gland 16.

The elastomeric material is resilient and is activated or energized, meaning that it compresses or expands thereby pushing the seal grid 10 or portions thereof, toward the chamber wall 4 or allows the seal grid 10 or portions thereof, to be compressed closer to the vane, or is capable of being simultaneously expanded and compressed, by the physical operation of the vane 2 as it oscillates in the chamber, by chamber pressure or by physical operation of the vane and chamber pressure. Examples of suitable elastomeric materials useful as the elastomeric seal backing 15 include but are not limited to: rubber, silicone, nylon, polyethylene of ultrahigh molecular weight, polyurethane, combinations of metals and synthetic rubbers and combinations thereof.

Comparatively, prior art embodiments of OVM seal grids used discrete axial or leaf springs between the seals and the seal glands to force the seals against the wall of the vane chamber. That arrangement did not provide positive contact along the entire length of the vane seal nor did it serve to seal the underside of the seal.

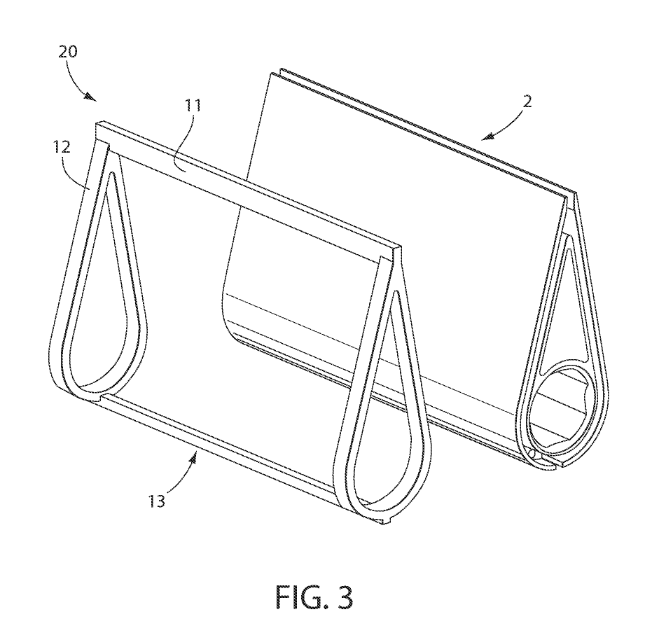

FIG. 3 shows an alternative embodiment of a seal grid 20, comprising a seal grid design that is pliable enough to fit into place over an OVM vane 2 as one piece, thereby enhancing vane 2 performance by combining improved positive contact as described in FIG. 2 with the elimination of lap joints 14 between separate segments of the seal grid 10 of the embodiment of FIG. 2. The benefit of this design is that it would eliminate any fluid leakage through the lap joints 14 of the embodiment of FIG. 2 in addition to eliminating any leakage around the underside of the seals 11, 12, 13 of the embodiment as shown in FIG. 3. Additionally, it is recognized that two, three, four or any higher number of vane seal grids 20 will further reduce leakage and increase friction.

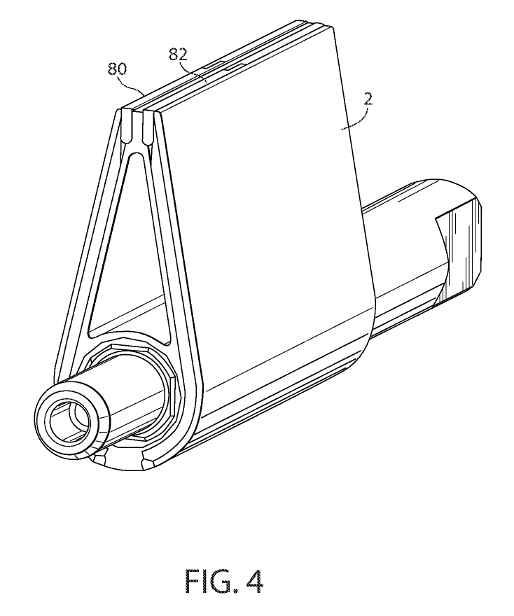

FIG. 4 shows another embodiment wherein the seal grid 80 comprises two separate elastomeric-backed seals 80, 82, on each side of the vane 2. With two seals 80, 82, leakage across the vane 2 is reduced, but friction losses increase. In applications where high pressure differentials exist across the vane 2, the power saved by reducing leakage will be far larger than the power lost due to additional friction.

Clearance Methods

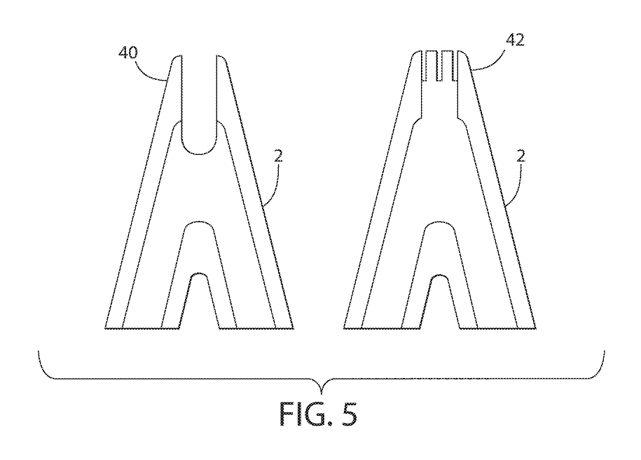

A clearance seal operates by reducing the available flow area from one volume to another such that it inhibits fluid flow. In general, the smaller the flow area and the tighter the tolerances held to maintain small gaps, the better the clearance seal will perform. FIG. 5 discloses an embodiment wherein the typical seal profile 40 of vane 2 is replaced with a labyrinth seal profile 42 of vane 2. Typically the benefits of a labyrinth include increasing the seal effectiveness or achieving the same seal effectiveness at larger clearances.

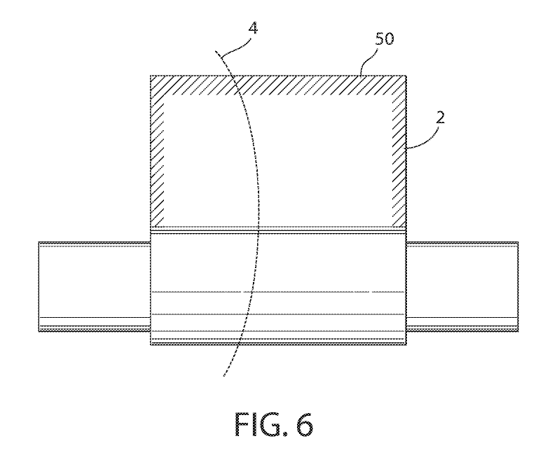

Another method of achieving a clearance seal is through the use of an abradable coating or a conformable coating. FIG. 6 shows a vane 2 wherein the hatched area 50 represents an abradable coating, a conformable coating, or a crushable coating.

Abradable seals are coatings that are machined in situ by moving components such as the vane 2 as it oscillates within its chamber 4 so that very close tolerances result and provide effective sealing of the gas paths. A variety of coatings are used for this purpose such as various polymers and of metals such as aluminum or bronze. Other abradable coatings include, but are not limited to: MCrAlYs (wherein M is Fe, Co, Ni or combinations thereof), polyester, hexagonal boron nitride as well as NiAl with polyester. An abradable coating 50 is applied to the vane 2, the chamber walls 4 or both. The OVM will go through a preliminary “break-in” period, where the machine will wear away the interfering material. The end result will be extremely tight clearances without the need for precise manufacturing tolerances.

Yet another means of achieving a clearance seal is through the use of a class of coatings described as “conformable.” A non-resilient conformable coating is applied to the vane 2, the chamber walls 4 or both. When the unit is assembled and the vanes 2 are oscillated, the coating conforms to the counter-face leaving a very small gap without the need for exceedingly tight manufacturing tolerances. As the unit reaches operating temperature, the coating continues to conform to the counter-face resulting in a very small operating clearance and therefore low leakage. Suitable conformable coatings include, but are not limited to iron phosphate, magnesium phosphate, nickel polymer amalgams, nickel zinc alloys, aluminum silicon alloys with polyester, and aluminum silicon alloys with polymethylmetacrylate (PMMA). One such conformable material, developed by Orion Industries Ltd., Chicago, is DB L-908, an ultrathin, closed-cell, polymer coating. It is mechanically compressible on the nanometer level and has zero compression recovery. DB L-908, a mixture of polyimide and other resins, contains nanometer-sized wear-resisting particles.

Still another method of achieving a clearance seal is through the use of a “crushable” coating or a “crushable vane. Such crushable coatings or crushable vanes include those made out of ceramic-based materials, matrices and composites, capable of withstanding manufacturing specifications but crushable when used within the OVM. The entire vane 2 or perimeter of the vane represented by the hatched area 50 in FIG. 5 is made from or coated with, a material that permanently deforms or “crushes” when the vane is assembled in its chamber in the OVM. Extremely tight clearances will result without the need for precise manufacturing tolerances. Further, the vane can be heated to a specific temperature before being “crushed” into position in the chamber so that when cooled, a specific clearance results at the machine's operating temperature.

Hybrid Methods

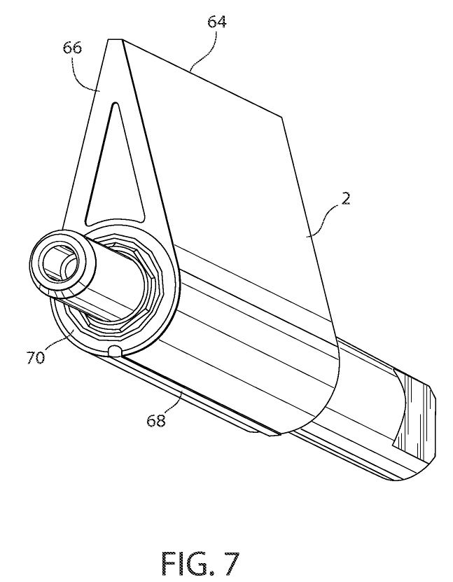

FIG. 7 shows one possible embodiment of a hybrid seal grid where the tip 64 sealing and much of the side 66 sealing of vane 2 is accomplished with a clearance seal and the bore 68 sealing and side 70 sealing near the bore 68 is accomplished with contacting seals. Sealing in this manner allows the designer to select a low cost contacting seal material at the same vane 2 oscillation speed or increase the vane 2 oscillation speed, use a high-performance seal material and increase the output of the OVM.

In addition to the Hybrid Method embodiment shown in FIG. 7, there are many other possible combinations of contacting and clearance seals for the differing parts of the vane 2. For instance, the side 66 seal could extend all the way to the tip 64 seal or the bore 68 seal could be a clearance seal.

The patent and scientific literature referred to herein establishes the knowledge that is available to those with skill in the art. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference.

While this invention has been particularly shown and described with references to preferred embodiments thereof, it will be understood by those skilled in the art that various changes in form and details may be made therein without departing from the scope of the invention encompassed by the appended claims. It should also be understood that the embodiments described herein are not mutually exclusive and that features from the various embodiments may be combined in whole or in part in accordance with the invention

1. A positive-contact seal grid for an Oscillating Vane Machine (OVM) vane, the positive-contact seal grid comprising at least one seal and an elastomer, and wherein the positive-contact seal grid is energized by the elastomer.

2. The positive-contact seal grid of claim 1 wherein the elastomer is energized by positive contact with a surface, pressure, axial springs, leaf springs or any combination thereof.

3. The positive-contact seal grid of claim 1 wherein the at least one seal is an elastomeric-backed seal and the seal grid comprises at least two elastomeric-backed seals.

4. The positive-contact seal grid of claim 3 wherein at least two elastomeric-backed seals are continuous.

5. The positive-contact seal grid of claim 1 wherein the vane comprises a tip, two sides, and a bore and the seal grid comprises one elastomeric-backed tip seal, two elastomeric-backed side seals, and one elastomeric-backed bore seal wherein the seals are continuous.

6. A clearance seal for an Oscillating Vane Machine vane of claim 14 wherein the vane comprises at least one flat surface and wherein the clearance seal comprises a labyrinth configuration applied to the at least one flat surface of the vane.

7. A clearance seal for a vane of an Oscillating Vane Machine (OVM) of claim 14 wherein the OVM comprises a stator with at least one chamber having the vane disposed therein and wherein the chamber further comprises walls, wherein the clearance seal comprises an abradable, conformable or crushable coating applied to the vane, the walls of a chamber or to both the vane and the walls of the chamber wherein upon operation of the OVM a clearance seal is formed.

8. A crushable vane for an Oscillating Vane Machine (OVM) of claim 14 wherein the OVM comprises a stator with at least one chamber having the crushable vane disposed therein, wherein the chamber further comprises walls, wherein the crushable vane conforms to the walls of the chamber upon operation of the OVM thereby forming a clearance seal.

9. A method for sealing at least one vane of an oscillating vane machine (OVM) wherein the vane comprises at least a first surface and a second surface, the method comprising:
a. applying a positive contact seal to a first surface; and
b. applying a clearance seal to a second surface.

10. A method for sealing at least one vane of an oscillating vane machine (OVM) of claim 9 wherein the vane comprises a tip, two sides and a bore, the method comprising:
a. applying a positive contact seal to the bore and a portion of the two sides near the bore; and
b. applying a clearance seal to the tip and a portion of the sides proximal to the tip.

11. The method of claim 9 wherein the positive-contact seals of step (a) comprise elastomeric-backed seals and the clearance seals of step (b) comprise an abradable, conformable or crushable coating.

12. The method of claim 10 wherein the positive-contact seals of step (a) comprise elastomeric-backed seals and the clearance seals of step (b) comprise an abradable, conformable or crushable coating.

13. A hybrid seal grid for an Oscillating Vane Machine (OVM) vane of claim 14 comprising a positive contact seal on at least one portion of the vane and a clearance-type seal on at least one portion of the vane.

14. A seal for an Oscillating Vane Machine (OVM) selected from the group consisting of:
a. a clearance seal for an OVM vane, wherein the vane comprises at least one flat surface and wherein the clearance seal comprises a labyrinth configuration applied to the at least one flat surface of the vane;
b. A clearance seal for an OVM vane wherein the OVM comprises a stator with at least one chamber having the vane disposed therein and wherein the chamber further comprises walls, wherein the clearance seal comprises an abradable, conformable or crushable coating applied to the vane, the walls of a chamber or to both the vane and the walls of the chamber wherein upon operation of the OVM a clearance seal is formed; and
c. a crushable vane for an OVM wherein the OVM comprises a stator with at least one chamber having the crushable vane disposed therein, wherein the chamber further comprises walls, wherein the crushable vane conforms to the walls of the chamber upon operation of the OVM thereby forming a clearance seal.
